(19) United States
(12) Patent Application Publication
(10) Pub. No.: US 2026/0176794 A1
(43) Pub. Date: Jun. 25, 2026

(54) A FABRIC WITH REGENERATED CELLULOSE

(71) Applicant: TreeToTextile AB, Stockholm (SE)

(72) Inventors: Ida ALNEMO, Spånga (SE); Carolin TRENKA, Hägersten (SE)

(73) Assignee: TreeToTextile AB, Stockholm (SE)

(21) Appl. No.: 19/125,988

(22) PCT Filed: Nov. 8, 2023
(86) PCT No.: PCT/SE2023/051132

§ 371 Date: Apr. 30, 2025

(30) Foreign Application Priority Data
Nov. 8, 2022 (EP) 22206114.5
Dec. 2, 2022 (SE) 2251405-3

(51) Int. Cl. D01F 2/06; B32B 5/26; D01F 2/00; D01F 2/24

(52) U.S. Cl. CPC D01F 2/06; B32B 5/26; D01F 2/00; D01F 2/24

(57) ABSTRACT

A fabric comprising cellulosic fibers regenerated from an alkaline, aqueous solution of cellulose in a spin bath. The dissolved cellulose has a degree of substitution of not more than 0.3. The fabric has good resistance to surface pilling. Further, it has improved color absorbing properties and good color fastness.

### FIELD OF THE INVENTION

The present invention relates to a cellulosic fabric, such as a knitted or a woven fabric, providing for better sustainability of fabrics. The fabric is less prone to form pills. Further, the fabric has improved color absorbing properties and good color fastness. Furthermore, the fabric is cotton like.

### BACKGROUND

Different fibers have different application areas in the textile industry. Historically, fibers used in textiles have been natural fibers originating from plants (cellulose, e.g. cotton), animals (protein, e.g. wool), or soil (minerals, e.g. asbestos).

Cotton (i.e. plant based fibers) has for a long time been the biggest natural fiber used in the textile industry. With about 24.7 million annual tonnes, it had a market share of approximately 22% of global fiber production in 2021.

Synthetic fibers have dominated the fiber market since the mid-1990s, when they overtook cotton volumes. With around 72 million annual tonnes of synthetic fibers, this fiber category made up approximately 64% of the global fiber production in 2021.

Man-made cellulosics fibers (MMCFs), with a global production volume of around 7.2 million annual tonnes, had a market share of around 6.4% in 2021. The global MMCF production volume has more than doubled from around 3 million tonnes in 1990 to approximately 7.2 million tonnes in 2021 (including viscose, acetate, lyocell, modal, and cupro), and is expected to further grow in the coming years.

Fabrics made from cellulosic fibers (natural as well as man-made) find use in variety of applications. Typical high volume applications are woven or knitted products that come in close contact to the skin, e.g. plain weave bed sheets and single jersey t-shirts.

Apart from natural fibers, like cotton, fibers, also man-made cellulosic fibers, like viscose, lyocell and modal fibers, are used in the textile industry. Viscose, lyocell, and modal fibers, apart from being an alternative to cellulosic fibers from another source, may provide fabrics with other properties, like increased drapability, luster, and moisture regain. However, man-made cellulosic fibers, like viscose, lyocell and modal fibers are typically not perceived as cotton like. While they indeed are alternative to cotton fibers, they are not any real replacement, or a true substitute to cotton fibers. They are not even considered as a surrogate, but rather as distinct, alternative materials, i.e. fiber that provides a fabric with other properties than cotton. Depending on the intended use, the properties may be seen as disadvantage, or an advantage. As example, viscose is widely used in blouses, whereas cotton typically is used in e.g. men's shirts.

Further, while man-made cellulosic fibers, like viscose, lyocell and modal fibers may increase properties like drapability, luster, and moisture regain, which may be of interest to increase, especially fabrics of viscose, but also fabrics of made of other man-made cellulosic fibers, like lyocell, suffer from substantially increased dry elongation compared to cotton fabrics. It may thus be of interest to provide an alternative to cotton being less prone to dry elongate than e.g. viscose.

Further, a common problem with fabrics comprising natural cellulosic fibers as well as man-made cellulosic fibers in the art, especially knitted fabrics, are their tendency to pilling. This affects the hand feel as well as the appearance of the fabric negatively which contributes to rejections of textile products by the user, resulting in impaired sustainability.

The EU-commission has in the Outline of the Commission proposal for Ecodesign for Sustainable Products Regulation identified that possible eco-design requirements for textiles comprise providing textiles having resistance to pilling and abrasion, as well as color fastness.

Another concern in the textile industry in relation to eco-design is coloring. Wet processes, like coloring of textiles, are one of the processes in the textile industry having the largest impact on the environment. It would be thus be desirable to provide cellulosic textiles having improved color absorbing properties, as this would allow for reducing the amount of dyestuff used; whereby the impact on the environment could be reduced. However, in order to take advantage of the improved color absorbing properties, colored textile would still have to have good color fastness (e.g. rubbing fastness, perspiration fastness, washing fastness, and light fastness).

Thus, there is a need in the art for a fabric comprising cellulosic fibers, which has improved resistance to pilling. Further, it would be preferred for the textile to have improved color absorption in order to reduce the amount dyestuff used in coloring of textiles. Furthermore, it would be preferred to provide a fabric being cotton like to be used as substitute or replacement to cotton.

### SUMMARY OF THE INVENTION

According to a first aspect of the invention there is provided a fabric comprising cellulosic fibers regenerated from an alkaline, aqueous solution of cellulose, i.e. a spin dope, in a spin bath. The dissolved cellulose is unsubstituted or has a degree of substitution of not more than 0.3.

According to an embodiment, the dissolved cellulose has a degree of substitution of not more than 0.1, such as not more than 0.05. According to an embodiment, the dissolved cellulose is unsubstituted. As known in the art, the degree of substitution may be determined inter alia by NMR.

According to an embodiment, the dissolved cellulose is substituted. If the cellulose is substituted, it may for example be esterified (cellulose acetate) and/or alkylated (e.g. ethyl cellulose, methyl cellulose, hydroxyethyl cellulose, hydroxypropyl cellulose, and/or carboxymethyl cellulose). The cellulose is however not cellulose xanthate, i.e. the cellulose has not been subject to xanthation by e.g. carbon disulfide. The cellulosic fibers regenerated from an alkaline, aqueous solution of cellulose in a spin bath are hence not viscose or rayon fibers.

Cellulosic fibers regenerated from an alkaline, aqueous solution of unsubstituted cellulose or from an alkaline, aqueous solution of cellulose with a low degree of substitution, i.e. not more than 0.3, typically not more than 0.1, in a spin bath have been found to have unique properties. The spin bath is typically alkaline. It may however according to alternative embodiments be acidic.

It has unexpectedly been found that a fabric comprising cellulosic fibers regenerated from an alkaline, aqueous solution of cellulose in a spin bath have increased color absorbing properties, i.e. it absorbs more of a coloring dye, such as a reactive dye, and/or a pigment used in textile coloring. This is advantageous, as less dyestuff can be used to provide a fabric with a given color. It was further found that a fabric, such as a woven or knitted fabric, comprising cellulosic fibers regenerated from an alkaline, aqueous solution of cellulose, in a spin bath are less prone to pilling. As recognized in the art, formation of pills is one of the main reasons for textiles and garments being discarded. Providing a garment with improved pilling resistance is of interest, as it would increase the user phase of textiles and garments and thereby provide more sustainable textiles and garments. A fabric comprising cellulosic fibers regenerated from an alkaline, aqueous solution of cellulose in a spin bath has further surprisingly been found to be more cotton like than fabrics comprising other man-made cellulosic fibers, e.g. viscose and lyocell. Thus, cellulosic fibers regenerated from an alkaline, aqueous solution of cellulose in a spin bath may be used as a substitute and/or as a replacement for a cotton fiber, and not simply as an alternative for a cotton fiber. However, it may also be of interest to use cellulosic fibers regenerated from an alkaline, aqueous solution of cellulose in a spin bath is a supplement to cotton in a cotton fabric, as some properties, like drapability, moisture regain, color absorption, and/or resistance to pilling, thereby may be improved.

The cellulosic fibers regenerated from an alkaline, aqueous solution of cellulose in a spin bath used to provide the fabric, be it a woven, knitted or non-woven fabric, may have a linear density of 0.5 to 3.0 dtex, such as 0.8 to 2.0 dtex. Whereas the cellulosic fibers regenerated from an alkaline, aqueous solution of cellulose in a spin bath may be filaments, they are typically staple fibers. In woven or knitted fabrics, the staple fibers are spun into a yarn used in the manufacture of the fabric, such as by weaving or knitting. As recognized in the art, the yarn count depends on the manufacturing process as well as the intended use of the fabric.

Cellulosic fibers regenerated from an alkaline, aqueous solution of cellulose in a spin bath represents a new type of man-made cellulosic fibers being distinct from existing generic man-made cellulosic fibers in the art, such as viscose fibers, lyocell fiber, modal fibers, and cupro fibers. They are further distinct from natural cotton fibers.

Various aspects of the provision of cellulosic fibers regenerated in an alkaline spin bath from an alkaline, aqueous solution of cellulose have been described inter alia in WO 2022/112425, WO 2021/211046, WO 2020/231315, WO 2020/171767, WO 2018/169479, WO2017/178531, WO 2017/178532, WO 2016/177534, WO 2015/000820, and WO 2010/104458, which all are incorporated by reference. Especially, WO 2020/171767 and WO 2017/178531 are exemplary for the provision of cellulosic fibers regenerated in an alkaline spin bath from an alkaline, aqueous solution of cellulose. The alkaline, aqueous solution of cellulose may comprises 5 to 10 wt. % sodium hydroxide, such as 6.5 to 8.5 wt. % sodium hydroxide. It may further comprise 4 to 12 wt. % cellulose. In addition, it may optionally comprise 0.1 to 2.7% ZnO.

According to a preferred embodiment, the cellulosic fibers regenerated from an alkaline, aqueous solution of cellulose in a spin bath are regenerated by spinning the alkaline, aqueous solution of cellulose—a spin dope—into an alkaline spin bath. In short, cellulose is dissolved in cold alkali to provide the alkaline spin dope. The spin dope may be wet-spun into an alkaline spin bath comprising sodium carbonate (Na₂CO₃) or sodium sulfate (Na₂SO₄) to provide regenerated cellulosic fibers. Typically, the alkaline spin bath comprises sodium carbonate (Na₂CO₃).

According to an alternative embodiment, the cellulosic fibers regenerated from an alkaline, aqueous solution of cellulose in a spin bath are regenerated by spinning an alkaline, aqueous solution of cellulose—a spin dope—into an acidic spin bath. The acidic spin bath may comprise sulfuric acid.

According to an embodiment, the cellulosic fibers regenerated from an alkaline, aqueous solution of cellulose in a spin bath have been formed by dissolving cellulose in an alkaline solution comprising 5 to 12 wt. % sodium hydroxide, such as 6 to 10 wt. % sodium hydroxide, at a temperature of +12° C. or lower, such as at a temperature of −20° C. to +10° C., −10° C. to +5° C., or −5° C. to +5° C., to form an alkaline spin dope. Subsequently, the alkaline spin dope is wet-spun into a spin bath, such as an 10 alkaline spin bath comprising 14 to 32 wt. % sodium carbonate (Na₂CO₃), such as 16 to 24 wt. % sodium carbonate (Na₂CO₃), to provide the cellulosic fibers regenerated from an alkaline, aqueous solution of cellulose in a spin bath. The cellulose to be dissolved in the alkaline solution comprising 5 to 12 wt. % sodium hydroxide may have a degree of polymerization (DP) of 140 to 600, such as 180 to 600, 200 to 400, 160 to 400, or 180 to 380. As can be seen, the cellulose to be dissolved may have a fairly low degree of polymerization. Further or alternatively, it may have an intrinsic viscosity according to ISO 5351:2010 (E) of 115 to 450 ml/g, such as 150 to 450 ml/g, 190 to 300 ml/g, 130 to 300 ml/g, or 140 to 290 ml/g. The degree of polymerization may be determined based on the intrinsic viscosity as determined according to ISO 5351:2010 (E) through the following equation in which n is the viscosity DP^{0.905}=0.75*η. The alkaline cellulose spin dope may comprise 4 to 12 wt. %, such as 5 to 8 wt. % cellulose. In order to affect the solubility, the alkaline solution to dissolve the cellulose may comprise zinc oxide (ZnO). It may comprise 2.7% by weight or less of zinc oxide (ZnO), such as 0.1 to 2.7% ZnO by weight, or even 0.5 to 1.6% ZnO by weight.

A wet, swollen tow is provided when the spin dope is spun into the spin bath. This tow of regenerated fibers may subsequently be withdrawn from the spin bath to provide cellulose fibers. After the cellulosic fibers have been regenerated, they are typically washed. They may be washed in a plurality of consecutive washing steps at alkaline conditions.

If the spin bath is alkaline, the fibers may be washed at subsequently lower pH-value until the washing liquid has a pH value of less than 10. The pH-value will be subsequently lower, as NaOH and sodium carbonate (Na₂CO₃) is extracted from the fibers.

The cellulosic fibers regenerated in the spin bath are filaments. The filaments may be cut into staple fibers. According to an embodiment, the present fabric comprises staple fibers. The staple fibers may be 15 to 75 mm long, such as 20 to 50 mm long. If to be used in a non-woven fabric, they may be shorter.

The present fabric may comprise various amounts of cellulosic fibers regenerated from an alkaline, aqueous solution of cellulose in a spin bath. In some embodiments, the fabric essentially consists of cellulosic fibers regenerated from an alkaline, aqueous solution of cellulose in a spin bath, whereas in other embodiments the fabric comprises other fibers as well, such as man-made cellulosic fibers distinct from the cellulosic fibers regenerated from an alkaline, aqueous solution of cellulose in a spin bath, such as lyocell and/or viscose fibers, cotton fibers, and/or polyester fibers.

According to an embodiment, the fabric comprises at least 20 wt %, such as at least 50 wt %, 60 wt %, 70 wt %, 80 wt %, or 90 wt %, of cellulosic fibers regenerated from an alkaline, aqueous solution of cellulose in a spin bath. According to such an embodiment, the fabric may essentially consist of cellulosic fibers regenerated from an alkaline, aqueous solution of cellulose in a spin bath. If to provide a uniformly colored fabric, it may be preferred to provide a fabric essentially consisting of cellulosic fibers regenerated from an alkaline, aqueous solution of cellulose in a spin bath.

According to an embodiment, the fabric comprises cellulosic fibers regenerated from an alkaline, aqueous solution of cellulose in a spin bath and an additional fiber. According to a first option of this embodiment, the fabric comprises 1 to 50 wt % of the cellulosic fibers regenerated from an alkaline, aqueous solution of cellulose in a spin bath, i.e. the cellulosic fibers regenerated from an alkaline, aqueous solution of cellulose in a spin bath is typically not the major fiber in the fabric according to this option. The fabric may comprise 5 to 40 wt % or 10 to 40 wt % of the cellulosic fibers regenerated from an alkaline, aqueous solution of cellulose in a spin bath. According to this first option, the cellulosic fibers regenerated from an alkaline, aqueous solution of cellulose in a spin bath may be used to affect properties such as the resistance to pilling and/or the color absorption of a fabric, i.e. the cellulosic fibers regenerated from an alkaline, aqueous solution of cellulose in a spin bath are used as a supplement to another fiber. Further, the cellulosic fibers regenerated from an alkaline, aqueous solution of cellulose in a spin bath may be used to provide more cotton like properties to a fabric comprising man-made cellulosic fibers, such as viscose, lyocell and modal fibers, distinct from the cellulosic fibers regenerated from an alkaline, aqueous solution of cellulose in a spin bath. Furthermore, the cellulosic fibers regenerated from an alkaline, aqueous solution of cellulose in a spin bath may be used to decrease dry-elongation of a fabric comprising man-made cellulosic fibers, such as viscose. According to a second option of this embodiment, the fabric comprises 50 to 99 wt % % of the cellulosic fibers regenerated from an alkaline, aqueous solution of cellulose in a spin bath, i.e. the cellulosic fibers regenerated from an alkaline, aqueous solution of cellulose in a spin bath are the major fiber in the fabric according to this option. The fabric may comprise 60 to 99 wt %, 70 to 97.5 wt % or 80 to 95 wt % of the cellulosic fibers regenerated from an alkaline, aqueous solution of cellulose in a spin bath. According to this second option, the cellulosic fibers regenerated from an alkaline, aqueous solution of cellulose in a spin bath may be supplemented by a second type of fibers, in an amount equal to or smaller than the amount of cellulosic fibers regenerated from an alkaline, aqueous solution of cellulose in a spin bath, to affect for example the structural integrity of the fabric. According to this embodiment, be it the first or second option thereof, the fabric may comprise further fibers selected from the group consisting of man-made cellulosic fibers distinct from the cellulosic fibers regenerated from an alkaline, aqueous solution of cellulose in a spin bath, such as lyocell and/or viscose fibers, cotton fibers, and polyester fibers.

According to an embodiment, the fabric comprises cellulosic fibers regenerated from an alkaline, aqueous solution of cellulose in a spin bath and an additional fiber. In such an embodiment, the fabric may comprise 50 to 90 wt %, such as 60 to 80 wt %, or 65 to 75 wt %, of the cellulosic fibers regenerated from an alkaline, aqueous solution of cellulose in a spin bath. Further, the fabric may comprise lyocell fibers. The fabric may comprise 10 to 50 wt % lyocell fibers, such as 20 to 40 wt % or 25 to 35 wt % lyocell fibers. The lycocell fibers will improve the structural integrity of the fabric. In some applications, e.g. in bed textiles, it may be preferred to supplement the cellulosic fibers regenerated from an alkaline, aqueous solution of cellulose in a spin bath with another fiber to provide e.g. the desired structural integrity, while still providing a cotton like material, i.e. a cotton substitute. In an embodiment, a fabric comprising cellulosic fibers regenerated from an alkaline, aqueous solution of cellulose in a spin bath and lyocell is used in an article like a bed textile. Thus, a bed textile, e.g. a bed-linen may comprise such a fabric. Further, the fabric may optionally comprise a third type of fiber. If present, the third type of fiber is typically present in a minor amount, such as less than 5 wt %. A third fiber may be an elastic fiber, such as an elastane fiber (also known as lycra and spandex). Elastane is a polyether-polyurea copolymer. Whereas elastane fiber provide elastic properties to fabrics, it may be less desirable from a recycling perspective.

According to an embodiment, the fabric comprises cellulosic fibers regenerated from an alkaline, aqueous solution of cellulose in a spin bath and an additional fiber. In such an embodiment, the fabric may comprise 20 to 80 wt %, such as 30 to 70 wt %, or to 60 wt %, of the cellulosic fibers regenerated from an alkaline, aqueous solution of cellulose in a spin bath. Further, the fabric may comprise cotton fibers. The fabric may comprise 20 to 80 wt % cotton fibers, such as 30 to 70 wt % or 40 to 60 wt % cotton fibers. The cotton fibers will improve the structural integrity of the fabric and ensuring the cotton like properties. In an embodiment, a fabric comprising cellulosic fibers regenerated from an alkaline, aqueous solution of cellulose in a spin bath and cotton is used in a bed textile, e.g. in bed-linen. Thus, a bed textile, e.g. a bed-linen may comprise such a fabric. Further, the fabric may optionally comprise a third type of fiber. If present, the third type of fiber is typically present in a minor amount, such as less than 5 wt %. A third fiber may be an elastic fiber, such as an elastane fiber (also known as lycra and spandex). Elastane is a polyether-polyurea copolymer. Whereas elastane fiber provide elastic properties to fabrics, it may be less desirable from a recycling perspective.

According to an embodiment, the fabric comprises cellulosic fibers regenerated from an alkaline, aqueous solution of cellulose in a spin bath and an additional fiber, such a viscose fiber. In such an embodiment, the fabric may comprise 5 to 50 wt %, such as 10 to 40 wt %, or 15 to 35 wt %, of the cellulosic fibers regenerated from an alkaline, aqueous solution of cellulose in a spin bath. Further, the fabric may comprise viscose fibers. The fabric may comprise 50 to 95 wt % viscose fibers, such as 60 to 90 wt % or 65 to 85 wt % viscose fibers. The cellulosic fibers regenerated from an alkaline, aqueous solution of cellulose in a spin bath will reduce the dry elongation of the fabric.

As commonly is the case in the textile industry, the fabric may be colored. The fabric may thus comprise a dyestuff, such as a reactive dye. Given that cellulosic fibers regenerated from an alkaline, aqueous solution of cellulose in a spin bath have higher coloring absorbing properties than other man-made cellulosic fibers and cotton, coloring a fabric comprising another type of fiber, apart from the cellulosic fibers regenerated from an alkaline, aqueous solution of cellulose in a spin bath, may provide the fabric with a mélange effect upon coloring of the fabric. According to an embodiment, the fabric has been colored by a dyestuff, and comprises cellulosic fibers regenerated from an alkaline, aqueous solution of cellulose in a spin bath and further fibers distinct from the cellulosic fibers regenerated from an alkaline, aqueous solution of cellulose in a spin bath. The further fibers may be selected from the group consisting of man-made cellulosic fibers distinct from the cellulosic fibers regenerated from an alkaline, aqueous solution of cellulose in a spin bath, such as lyocell, and/or viscose fibers, cotton fibers, and polyester fibers.

In a broad sense, the fabric may be any kind of fabric such as a knitted fabric, a woven fabric, or non-woven fabric. However, the fabric is typically a knitted fabric, such as a fabric having a jersey, rib or purl construction, or a woven fabric such as a fabric having a plain weave, twill (e.g. denim) or satin construction. According to an alternative embodiment, the fabric is a non-woven fabric.

According to an embodiment, the fabric is a circular knit fabric. The circular knit fabric may have single jersey construction. Circular knit fabrics are used in wide variety of garments, a typical example being T-shirts. Further examples include sweaters, polos, pikes, dresses, sweatpants, and fitted jersey bed sheets. Further, the fabric may be a flat knit fabric, or a warp knit fabric. Flat knit fabrics are mainly used for knitted jumpers, cardigans, slipovers. Warp knit fabrics are used in wide variety of garments and home textiles, typical examples being sportswear, underwear, lingerie and curtains. The warp knit fabric may be a tricot fabric.

According to an exemplary embodiment, the fabric is a fabric having a jersey construction, with a mass per unit area of 60 to 400 g/m² determined according to SS-EN 12127:1997 with a sampling procedure with load according to ISO 3801:1977. Further, its thickness may be 0.5 to 2 mm according to SS-EN ISO 9073-1:1995. By using at least a portion of cellulosic fibers regenerated from an alkaline, aqueous solution of cellulose in a spin bath, the fabric's resistance to surface pilling may be improved. The fabric according to this exemplary embodiment may have a resistance to surface pilling of at least 3, preferably at least 4, as determined according to SS-EN ISO 12945-2:2020 in a Martindale apparatus after at least 5000 rubs, such as 7000 rubs. The yarn may be a Ne 16/1 to Ne100/1 ring spun yarn.

According to exemplary embodiment, the fabric is a woven fabric having a thread count (warp and weft) of 75 to 600 per square inch, such as a thread count of 100 to 400 per square inch. The woven fabric may be a woven fabric with plain weave construction. A woven fabric with plain weave construction may be a sheeting for bed-linen. The yarn used to produce the woven fabric according to this embodiment may be a Ne 12/1 to Ne100/1 ring spun yarn. Further, the yarn may be open-end spun yarn or airjet spun yarn.

According to exemplary embodiment, the fabric is denim. The denim is typically colored, such as colored by indigo. As recognized in the art, denim is woven warp-faced fabric in which the weft passes under two or more warp threads providing the fabric with a diagonal ribbing. The denim may be light-weight denim, typically having a surface weight of 200 to 340 g/m². Light-weight denim is used inter alia in summer jeans and denim shirts. Further, the denim may be medium-weight denim, typically having a surface weight of 340 to 410 g/m². Medium-weight denim is used inter alia in standard jeans and jackets.

As explained herein above, cellulosic fibers regenerated from an alkaline, aqueous solution of cellulose in a spin bath are fibers that provide fabrics with improved resistance to surface pilling. According to an embodiment the cellulosic fibers regenerated from an alkaline, aqueous solution of cellulose in a spin bath are fibers that when tested by being incorporated in a flat knit fabric with a single jersey construction a mass per unit area of 275 to 295 g/m² determined according to SS-EN 12127:1997 with a sampling procedure with load according to ISO 3801:1977, and a thickness of 1.0 to 1.3 mm according to SS-EN ISO 9073-1:1995, provides the flat knit fabric with a resistance to surface pilling of at least 3, preferably at least 4, as determined according to SS-EN ISO 12945-2:2020 in a Martindale apparatus after at least 5000 rubs, such as 7000 rubs. In such a fabric, the fibers may be present as a yarn with a yarn count of Ne 16/2.

According to a second aspect of the invention there is provided an article comprising the fabric described herein above. The article may be a home furnishing textile article, such as an article of bedding, also denoted bed textile in the art, (e.g. a sheet, a quilt cover and/or pillow case), a blanket, a towel, a table cloth, a curtain, or a cover, or a garment, such as a T-shirt, a pair of trousers (e.g. jeans or chinos), a sweatshirt, a shirt, a blouse, a dress, underwear or a lingerie.

According to a third aspect of the invention there is provided for use of a cellulosic fiber regenerated from an alkaline, aqueous solution of cellulose in a spin bath in a fabric to provide the fabric with improved resistance to pilling. Aspects of the fiber as well as the fabric, described herein above, are equally applicable to such use. Especially, the fabric may be a knitted fabric, such as a knitted fabric having jersey construction, or a woven fabric.

According to a fourth aspect of the invention there is provided for use of a cellulosic fiber regenerated from an alkaline, aqueous solution of cellulose in a spin bath in a fabric to provide the fabric with improved color absorption. Aspects of the fiber as well as the fabric, described herein above, are equally applicable to such use. Especially, the fabric may be a knitted fabric, such as a knitted fabric having jersey construction, or a woven fabric.

According to a fifth aspect of the invention, there is provided for use of a cellulosic fiber regenerated from an alkaline, aqueous solution of cellulose in a spin bath as a substitute and/or replacement, for a cotton fiber; not merely as an alternative, like other man-made cellulosics fibers. Aspects of the fiber as well as the fabric, described herein above, are equally applicable to such use. Especially, the fabric may be a knitted fabric, such as a knitted fabric having jersey construction, or a woven fabric. According to one embodiment, the fabric comprises less than 5 wt. % cotton fibers, such as less than 2.5 wt. % cotton fibers.

According to a sixth aspect of the invention, there is provided for use of a cellulosic fiber regenerated from an alkaline, aqueous solution of cellulose in a spin bath in a cotton fabric as a supplement to a cotton fiber in a cotton fabric. The fabric comprises a cellulosic fiber regenerated in an alkaline spin bath and cotton fibers. Further, in such use, the cellulosic fiber regenerated from an alkaline, aqueous solution of cellulose in a spin bath may not only be used as a supplement, but also to:
increase drapability; and/or
improve the moisture regain; and/or
improve color absorption; and/or
improve resistance to pilling.

According to a seventh aspect of the invention, there is provided for use of a cellulosic fiber regenerated from an alkaline, aqueous solution of cellulose in a spin bath in a fabric as a supplement to another man-made cellulosic fiber, such as viscose, in order to decrease the dry elongation of the fabric. The fabric comprises a cellulosic fiber regenerated from an alkaline, aqueous solution of cellulose in a spin bath and another man-made cellulosic fiber, such as viscose. According to an embodiment, the fabric comprises 5 to 50 wt %, such as 10 to 40 wt %, or 15 to 35 wt %, of the cellulosic fiber regenerated from an alkaline, aqueous solution of cellulose in a spin bath. Further, the fabric may comprise viscose fibers. The fabric may comprise 50 to 95 wt % viscose fibers, such as 60 to 90 wt % or 65 to 85 wt % viscose fibers.

Without further elaboration, it is believed that one skilled in the art may, using the preceding description, utilize the present invention to its fullest extent. The preceding preferred specific embodiments, as well as the succeeding examples, are, therefore, to be construed as merely illustrative and not limitative of the disclosure in any way whatsoever.

Although the present invention has been described above with reference to specific embodiments, it is not intended to be limited to the specific form set forth herein. Rather, the invention is limited only by the accompanying claims and other embodiments than the specific embodiments described above are equally possible within the scope of these appended claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an”, “first”, “second” etc. do not preclude a plurality.

### DRAWINGS

FIG. 1 The photographs in FIG. 1 show a side view (FIG. 1a) and a cross-section (FIG. 1b) of cotton fibers;

FIG. 2 The photographs in FIG. 2 show a side view (FIG. 2a) and a cross-section (FIG. 2b) of viscose fibers;

FIG. 3 The photographs in FIG. 3 show a side view (FIG. 3a) and a cross-section (FIG. 3b) of lyocell fibers;

FIG. 4 The photographs in FIG. 4 show a side view (FIG. 4a) and a cross-section (FIG. 4b) of cellulose fibers re-generated from an alkaline, aqueous solution of cellulose in an alkaline spin bath;

FIG. 5 The table in FIG. 5 provides the complete data for testing of resistance to surface pilling; and

FIG. 6 The diagram in FIG. 6 shows the relative color uptake of the inventive fabric and various fabrics in the art.

FIG. 7 The photographs in FIG. 7 show the relative color uptake of various man-made cellulosic fibers.

### EXAMPLES

In order to evaluate the properties of unsubstituted cellulose fibers regenerated in an alkaline spin bath from cellulose dissolved in cold alkali (herein denoted TTT fibers), such fibers were studied and compared to other cellulosic fibers (cotton, viscose and lyocell fibers) used as benchmark fibers.

The benchmark fibers were selected to represent fiber types produced in industrial scale and used in large scale on the market. The viscose fibers were produced in China, the lyocell fibers were produced in Europe and the cotton was grown in Africa.

For a conditioned single fiber (ISO 139:2005, (20±2)° C. and (65±4) % RH), the linear density of the fibers used is shown in Table 1.

TABLE 1
linear density of tested fibers

| Fiber | Linear density (Titer) |
|---|---|
| TTT fibers*: | 1.50 dtex |
| Viscose: | 1.40 dtex |
| Lyocell: | 1.31 dtex |
| Cotton: | 1.96 tex |

*cellulose fibers regenerated in an alkaline spin bath from cellulose dissolved in cold alkali (cf. inter alia WO 2022/112425, WO 2021/211046, WO 2020/231315 WO 2020/171767, WO 2018/169479, WO2017/178531, WO2017/178532, WO 2016/177534, WO 2015/000820, and WO 2010/104458)

### Morphology

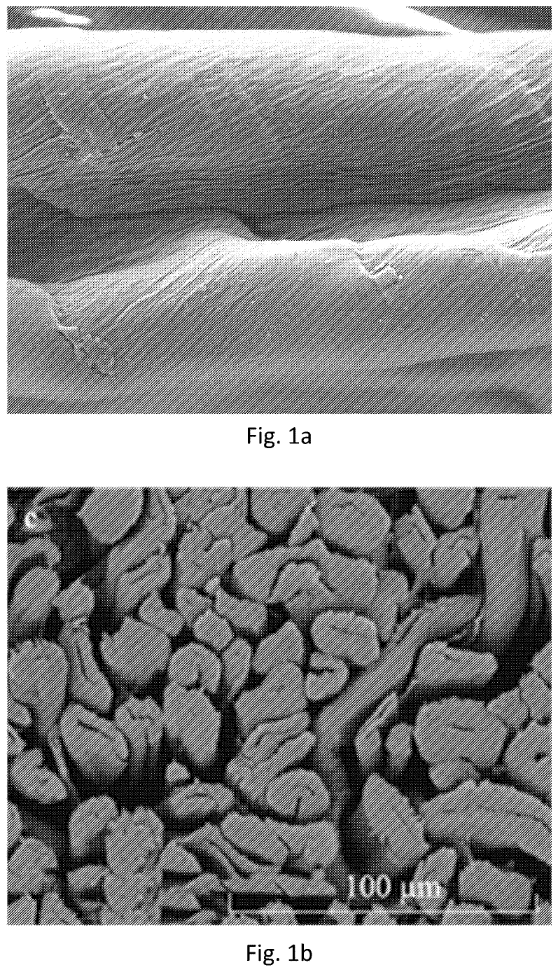

The morphology was studied in electron microscope. As can be seen in FIGS. 1 to 4, the morphology differs between the fibers even though their chemical composition is essentially the same (all are cellulosic fibers).

### Cotton

In FIG. 1, microscopic pictures of cotton are shown. Cotton is a natural cellulosic fiber (Cellulose I/Native Cellulose) given its shape by nature. As can be seen in FIG. 1b, the cross section is flat and has a kidney like shape with a lumen in the center. Further, as can be seen in FIG. 1a the surface in rough and has lengthwise convolutions in the fiber axis direction.

### Viscose

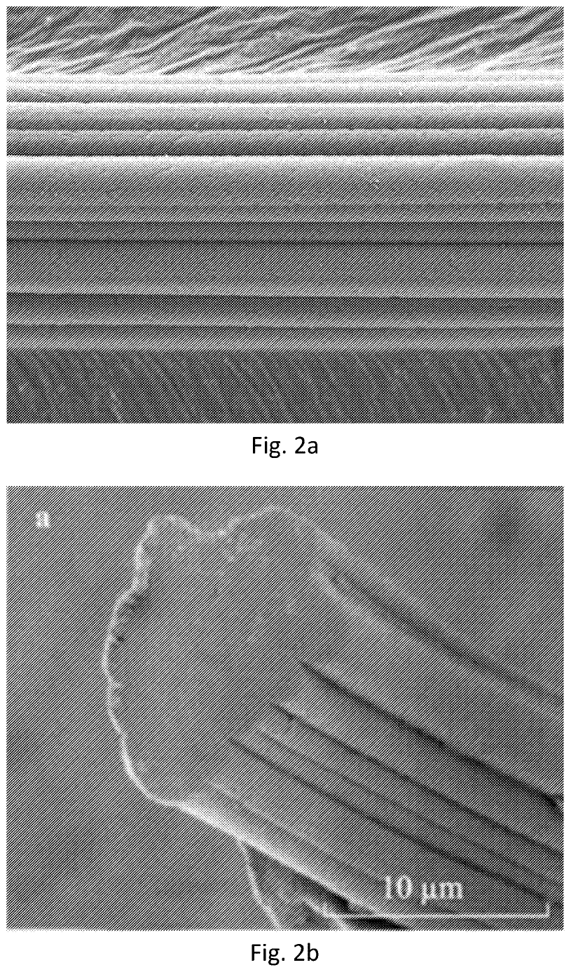

In FIG. 2, microscopic pictures of viscose fibers are shown. The viscose fiber is given its shape in the fiber spinning process. When the alkaline spin dope, comprising cellulose xanthate, enters the acidic spin bath the fiber surface instantly solidifies (giving the fiber an outer skin) and the inner part of the fiber collapses giving the fiber its final shape. As can be seen in FIG. 2b, the cross section therefore has an irregular petalous shape with several ridges in the fiber axis direction (cf. FIG. 2a).

Further, modal fibers (not shown) are produced in the same way as viscose fibers, but with different settings. Therefore, a modal fiber looks like a swollen (mercerized) viscose fiber having a smooth petal or bean like shape with less ridges in the fiber axis direction.

### Lyocell

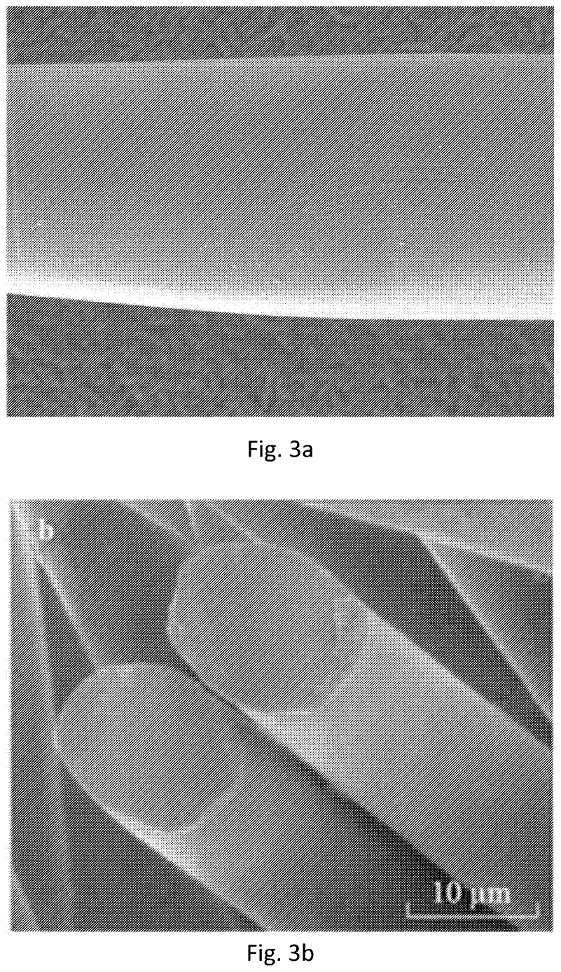

In FIG. 3, microscopic pictures of lyocell fibers are shown. The Lyocell fibers are given their shape in the fiber spinning process. When the spin dope enters the air gap (1-2 cm) of the dry jet wet spinning process the fibers get their final shape. As can be seen in FIG. 3b, the cross section is circular, and the surface appearance is smooth (cf. FIG. 3a).

### Tree to Textile Technology Fiber

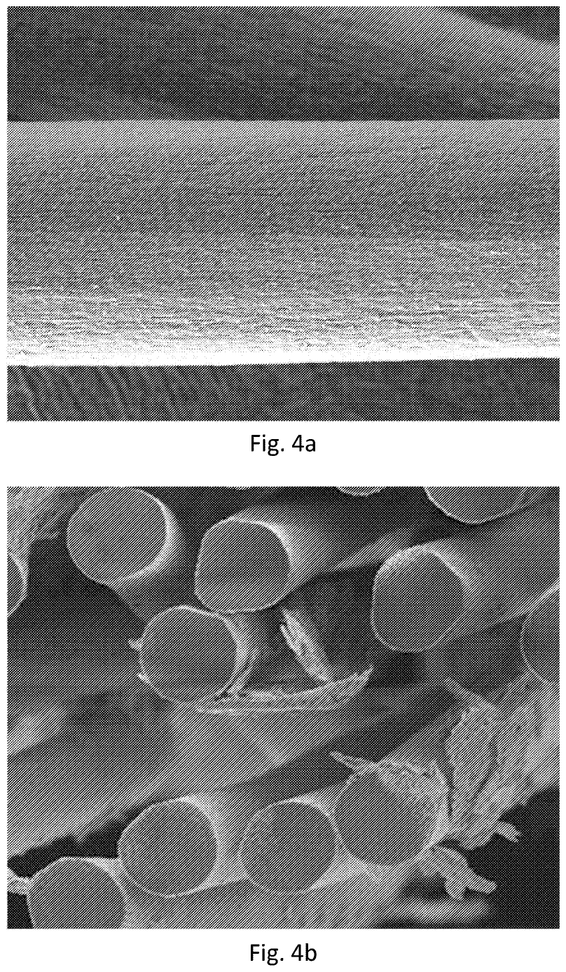

In FIG. 4, microscopic pictures of cellulose fibers regenerated from an alkaline, aqueous solution of cellulose in an alkaline spin bath are shown. Such fibers regenerated are given their shape in the fiber spinning process. When the cold alkaline spin dope enters the alkaline spin bath, comprising sodium carbonate, the fiber slowly transforms from its gel like structure into a solid fiber and eventually gets its final shape at the end of the washing process. The regeneration takes place during the gelation and precipitation. As can be seen in FIG. 4b, the cross section is circular like the one of lyocell (cf. FIG. 3b), but the surface appearance is rough and more cotton like (cf. FIG. 4a; NB the flakes in the pictures are epoxy used to fix the fibers when performing SEM microscopy).

### Yarn

The fibers were opened (Ramella Opener 500 mm working width), carded (Ramella carding machine 800 mm working width), drafted (Stirolab Mesdan 6.1 m/min) and ring spun (Sermantes spinning frame, T flange 1, 45 mm, Z direction, 600-850 tmp) and plyed (Plyer for short fibers-12 spindles, S direction, 360 tmp) into yarns. Essentially the same settings were used for all fibers. The yarn count of the yarn is indicated in Table 2.

TABLE 2
yarn

| Fiber | Yarn count |
|---|---|
| TTT fibers: | Ne 16/2 |
| Viscose: | Ne 16/2 |
| Lyocell: | Ne 16/2 |
| Cotton: | Ne 16/2 |

### Knitted Fabric

The yarn was knitted on a whole garment computerized flat knit machine (Shima Seiki Mach2XS153, 15 GG) to provide a flat knit fabric with single jersey construction. The surface density and the thickness of the fabrics are given in Table 3. Mass per unit area was determined according to SS-EN 12127:1997 for the single jersey fabric samples. The sampling procedure with load according to ISO 3801:1977. The thickness of single jersey fabric was determined according to SS-EN ISO 9073-1:1995. Five test specimens were tested. A PTE thickness tester with standard presser-foot (0.5 kPa) was used.

TABLE 3
fabric density and thickness

| Fiber | Surface density (mean 5 tests) | Thickness (mean 5 tests) |
|---|---|---|
| TTT fibers | 282 g/m² | 1.15 mm |
| Viscose | 228 g/m² | 1.03 mm |
| Lyocell | 270 g/m² | 1.04 mm |
| Cotton | 257 g/m² | 1.25 mm |

The general appearance for all samples after 10 washes was essentially the same (data not shown). As described below, inter alia the resistance to surface pilling and the coloring properties of the fabrics were evaluated.

### Example 1—Resistance to Surface Pilling

Resistance to surface pilling of the fabrics were determined according to ISO 12945-2:2020 in a Martindale apparatus with 7000 rubs.
Number of specimens: two (one for each abradant)
Abradant: Test material and wool fabric
Loading weight: 155±1 g.
Number of observers: one (1)
Viewing conditions: Light Cabinet Ortospectra 60, D65, worst angle.

TABLE 4
Resistance to surface pilling (7000 rubs)

| | Resistance to surface |
|---|---|
| Fiber | pilling - grade |
| TTT fibers: | 4-5 |
| Viscose: | 1-2 |
| Lyocell: | 2 |
| Cotton: | 1 |

TABLE 5
Visual assessment of pilling - Grading scheme

| Appearance | Grade |
|---|---|
| No change | 5 |
| Partially formed pills | 4 |
| Moderate pilling- pills of varying size and density partially | 3 |
| covering the specimen surface | |
| Distinct pilling- pills of varying size and density | 2 |
| covering a large proportion of the specimen surface | |
| Severe pilling- pills of varying size and density, | 1 |
| covering the whole of the specimen surface | |

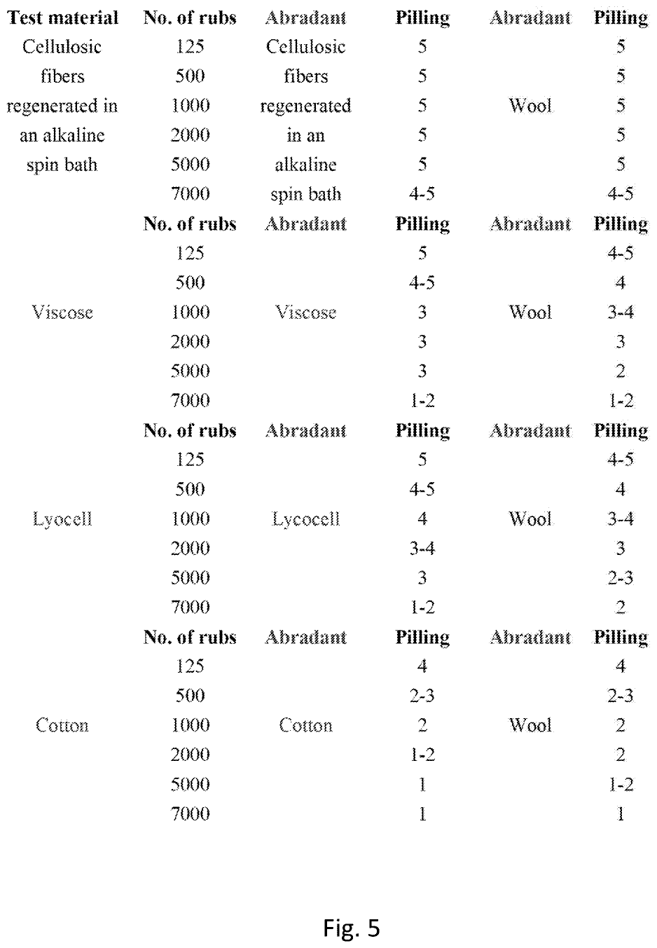

The complete data set for the resistance to surface pilling is given in FIG. 5. As can been seen from Table 4 and FIG. 5, the resistance to surface pilling is superior for fabric comprising cellulosic fibers regenerated from an alkaline, aqueous solution of cellulose in an alkaline spin bath compared to the other tested cellulosic fibers.

For washed fabrics (10 times) the resistance to surface pilling was somewhat improved. The fabric comprising cellulosic fibers regenerated from an alkaline, aqueous solution of cellulose in an alkaline spin bath were however still superior. The resistance to fuzzing for washed fabric comprising cellulosic fibers regenerated from an alkaline, aqueous solution of cellulose in an alkaline spin bath was also superior compared to the other tested cellulosic fibers. Similarly, the resistance to matting for washed fabric comprising cellulosic fibers regenerated from an alkaline, aqueous solution of cellulose in an alkaline spin bath was also higher compared to the other tested cellulosic fibers.

It should be noted that 7000 rubs represent very harsh conditions. Even a grade of three (3) would have been an excellent result after 7000 rubs. A grading of more than three (3) after 7000 rubs is a very unique result for a knitted fabric.

As known in the art, formation of pills is a complex process. Interestingly, the number of pills remains low for TTT fibers over the entire test cycle. This indicates that they provide the fabric with unique properties. Not only is the tendency to form pills low. Without being bound to any theory, it also seems that pills eventually formed (at least to some context they will inherently form) will be rapidly worn out.

In summary, from comparison trials made with fabrics comprising cellulosic fibers regenerated in an alkaline spin bath from cellulose dissolved in cold alkali, cotton fibers, viscose fibers or lyocell fibers, it can be concluded that cellulosic fibers regenerated in an alkaline spin bath provides fabric having a unique combination of fiber properties. Handfeel (drape), appearance (luster), comfort (moisture regain, elongation), and care (washability) places it (data not shown) between a natural cellulosic fiber, i.e. cotton fibers, and man-made cellulosic fibers, (i.e. viscose and lyocell fibers). In summary, cellulosic fibers regenerated from an alkaline, aqueous solution of cellulose in an alkaline spin bath are perceived as more cotton like than other man-made cellulosic fibers (cf. Example 4).

However, cellulosic fibers regenerated in an alkaline spin bath from cellulose dissolved in cold alkali have additional unique properties in their very good pilling resistance. Further, as described below, also the color uptake is improved with the color fastness still being good. These unique properties have impact on the application's longevity, its processability, the environmental footprint and the cost.

Further, when blending cellulosic fibers regenerated from an alkaline, aqueous solution of cellulose in an alkaline spin bath with other cellulosic fibers, the superiorities of the cellulosic fibers regenerated in an alkaline spin bath can bring extra enhancements to the resulting fiber blends (data not shown).

Furthermore, in consumer testing several test objects commented on the noticed pilling of viscose after washing. No corresponding comments for given for TTT, whereas some comments were given for cotton after washing.

### Example 2—Fabric Dyeing in an Exhaust Dyeing Process with Reactive Dyes

The coloring properties of in total five fabrics were evaluated. The fabric were produced as described above.

Fabric:

| | |
|---|---|
| No. 1 | Pre-washed Lyocell |
| No. 2 | Scoured Cotton |
| No. 3 | TTT Unwashed |
| No. 4 | TTT Pre-washed |
| No. 5 | Pre-washed Viscose |

### Pretreatment

In order to allow for coloring of the cotton fabric, it was pretreated with a scouring solution to remove the waxes inherently present in cotton. The scouring solution used to pre-treat the cotton fabric comprised Imerol NLF liq (1.5 ml/l), Lufibrol ANTOX liq (1.0 ml/l), and NaOH 50% (1.5 ml/l). The liquor ratio was 1:10. The fabric was scoured for 30 min. at 80° C., rinsed (warm and cold), and neutralized with Sirrix NE liq 0.5 ml/l.

Further, man-made cellulose fibers are typically provided with a spin-finish. These fibers were thus pre-washed to avoid the spin-finish affecting the outcome.

However, in order to evaluate the need for pre-wash of TTT, an un-washed specimen was included.

### Coloring

The fabrics were separately colored in five colors (four different brown hues and one black). The coloring compositions used comprised different amounts and combinations of dyes, having different shades and reactivity. The coloring compositions used are provided below:
1) Brown 1/9 SD: Drimaren HF-2GL (0.28 wt. %), Drimaren HF-6BL (0.35 wt. %), Blue HF-RL (0.22 wt. %), Leonil EHC liq (1 mg/l), Glauber salt (60 mg/ml), and soda (10 g/l);
2) Brown 1/3 SD: Drimaren HF-2GL (0.86 wt. %), Drimaren HF-6BL (1.05 wt. %), Blue HF-RL (0.66 wt. %)), Leonil EHC liq (1 mg/l), Glauber salt (70 mg/ml), and soda (15 g/l);
3) Brown 1/1 SD: Drimaren HF-2GL (2.6 wt. %), Drimaren HF-6BL (3.2 wt. %), Blue HF-RL (2.0 wt. %), Leonil EHC liq (1 mg/l), Glauber salt (70 mg/ml), and soda (20 g/l);
4) Deep brown: Drimaren Ultimate Amber HD (2.0 wt. %), Rubine HD (0.6 wt. %), Navy HD (1.5 wt. %), Leonil EHC liq (1 mg/l), Glauber salt (70 mg/ml), and soda (20 g/l);
5) Black: Drimaren Ultimate Amber HD (0.7 wt. %), Rubine HD (0.5 wt. %), Black HD (8.0 wt. %), Leonil EHC liq (1 mg/l), Glauber salt (90 mg/ml), and soda (20 g/l);

The fabrics were soaked in the coloring solutions (liquid color ration 1:10), heated to 60° C. (1.5° C./min) and kept at 60° C. for 90 minutes. Each fabric was soaked in a separate coloring bath. The fabrics were then rinsed at 25° C. with water for 10 min and neutralized with acetic acid (0.5 mg/ml) for 10 minutes. Thereafter, the fabrics were soaped with Cyclanon XC-W (1.5 mg/l), by soaking them in the soap solution, heating them to 60° C. (1.5° C./min) and keeping them at 60° C. for 90 minutes. At last, the colored fabrics were rinsed at 25° C. with water for 10 min.

No difference in color fastness (Color fastness to rubbing-ISO 105-X12:2016, color fastness to perspiration-ISO 105-E04:2013, color fastness to domestic and commercial laundering-ISO 105-C06:2010, or Color fastness to artificial light-ISO 105-B02:2015) could be found for the various fabrics, neither for the lighter colors, nor the darker.

It was however visually seen that the TTT-fabrics (fabric 3 and 4) were darker than the other corresponding fabrics, indicating that they more efficiently take up color. As no difference in color fastness is seen, the darker color of the TTT-fabrics is not the result of oversaturation.

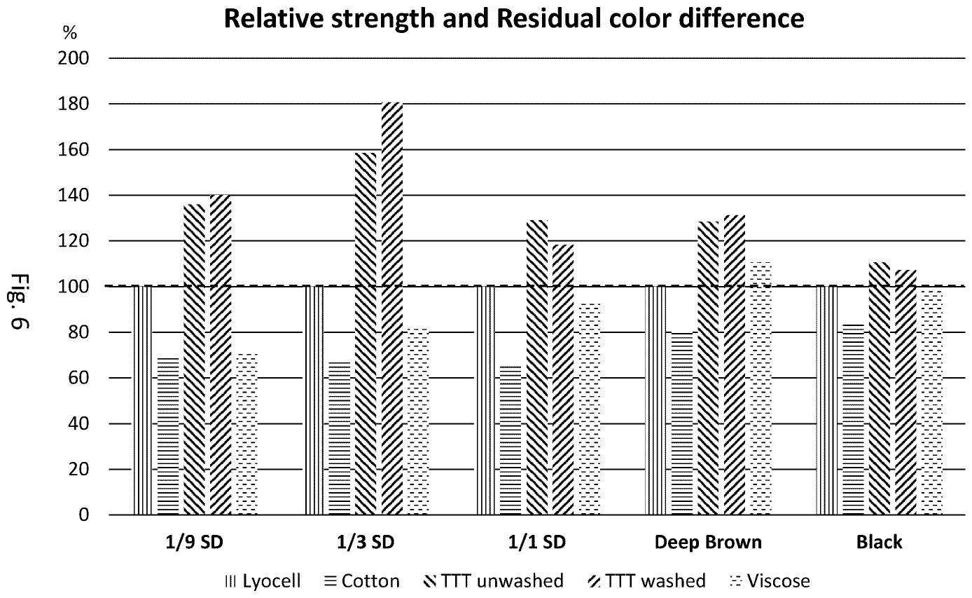

The color uptake was further measured by comparing the color yield of the different fabrics in the different recipes by colorimetric measurements. This is called “Relative strength and Residual color difference” and the results are given in Table 6 and FIG. 6.

TABLE 6
Relative strength and Residual color difference

| | | | TTT | TTT | |
|---|---|---|---|---|---|
| | Lyocell | Cotton | (unwashed) | (washed) | Viscose |
| 1/9 SD | 100 | 69 | 136 | 140 | 71 |
| 1/3 SD | 100 | 68 | 159 | 181 | 82 |
| 1/1 SD | 100 | 66 | 129 | 118 | 92 |
| Deep | 100 | 81 | 129 | 131 | 111 |
| Brown | | | | | |
| Black | 100 | 84 | 111 | 107 | 99 |

In this trial, lyocell was set as benchmark (100%) as it absorbs color better than cotton and viscose, respectively. The color yield is then measured as the percentage (%) of the color of the benchmark lyocell fiber (<100%=lighter; and >100%=darker). For example, as can be seen in Table 6, in the Brown 1/3 SD recipe, the color yield of the washed TTT sample (181%) is higher than for any of the other cellulose fibers (lyocell: 100% (ref.), cotton: 68%, and viscose: 92%) when using the same recipe.

Interestingly, it was found that cellulosic fibers regenerated in an alkaline spin bath from cellulose dissolved in cold alkali have improved color uptake without suffering from impaired color fastness, often inherently linked to increased color uptake. In coloring cellulosic fibers regenerated from an alkaline, aqueous solution of cellulose in an alkaline spin bath, less coloring agent is thus needed.

The results were confirmed in subsequent tests, wherein a lyocell and a TTT fabric, respectively, were colored to the same yield (i.e. the same color depth) with a coloring compositions comprising Drimaren orange HF 2GL CDG, Drimaren Rosso HF6BL, and Drimaren Blue HFRL. It was shown that with TTT-fabrics, less pigment (20 to 30 wt. % less) was needed to provide the same color depth of shade.

### Example 3—Fiber Coloring by Direct Dyeing Agent

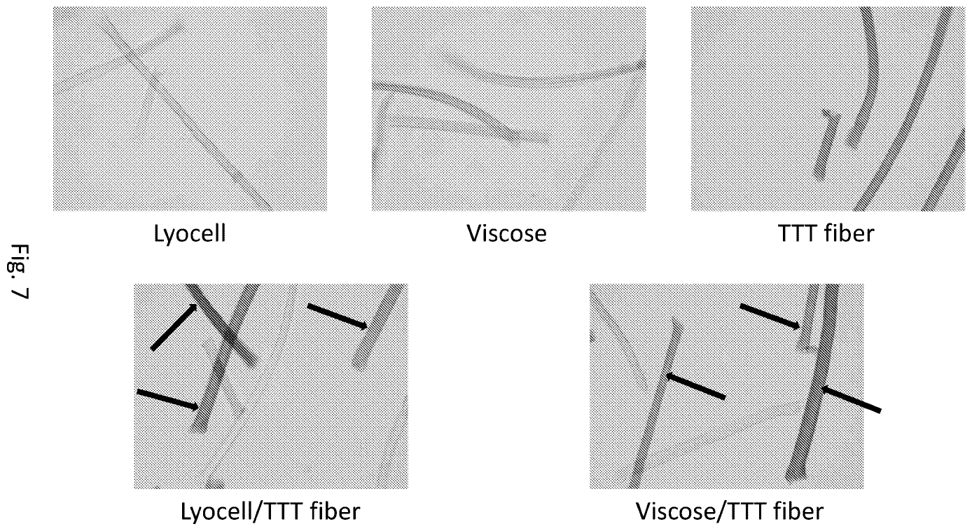

In a further example, the coloring of man-made cellulose fibers (TTT, viscose and lyocell) by a direct dyeing agent was evaluated. The coloring trials were carried out by preparing the stain solution as specified in ISO 21915-2 clause 5.5 and the following procedure specified in clause 7, but with the decoloring step (clause 7.3) omitted, as the various samples were not colored to start with (i.e. were in greige or ecru form). The same batch of prepared staining solution was used for each fiber, but divided into smaller and separate volumes to ensure a consistency of the staining for each fiber being stained. Fiber samples of 100% viscose, lyocell and TTT fiber were stained in separate vessels and initially examined under a light microscope to ascertain whether the staining (coloration) was even on all fibers. The initial examination indicated relatively even coloration of the fibers for each individual fiber type, which had been colored. In addition, it also indicated that the depth of colouration differed markedly for TTT (i.e. it appeared much darker than for cotton, viscose or lyocell). Importantly, it was noted that the depth of coloration (cf. FIG. 7) differed markedly for TTT (i.e. it appeared much darker than for cotton, viscose or lyocell). In the pictures in the upper row in FIG. 7 the resulting color of one type fiber are shown.

Further, a series of samples were prepared using random mixing of small portions of stained fibers of different types which were then mixed on the microscope slide using a needle. The amount of each fiber mixed was not determined. The pictures in the lower row in FIG. 7 show the resulting colors of mixtures (TTT fiber are indicated by arrows).

In summary, as can be seen in FIG. 7, TTT fiber are significantly darker, confirming the improved color uptake off TTT-fibers.

### Example 4—Hand Feel User Test

A summary of a hand feel user test results (the test procedure is outlined below) with the same type fabrics as in example 1 is presented below in Table 6. The table show the overall ranking of the different fabric properties evaluated: smoothness, roughness, lustre, cotton-like, and natural. The result is divided for unused fabrics/washed fabrics. The highest ranking is 1 and the lowest ranking is 4.

TABLE 6
Summary results: overall ranking

| Results un-used/washed | Viscose | TTT | Cotton | Lyocell |
|---|---|---|---|---|
| Smoothness ranking | 1/1 | 3/3 | 4/4 | 2/2 |
| Roughness ranking | 4/4 | 2/1 | 1/2 | 3/3 |
| Luster ranking | 1/2 | 3/3 | 4/4 | 2/1 |
| Cotton like ranking | 4/1 | 1/3 | 2/2 | 3/4 |
| Natural ranking* | 4/3 | 2/2 | 1/1 | 3/3 |

*Viscose and lyocell both overall ranked third on the parameter “Natural” for washed fabrics

### Method and Materials

The materials subjected to testing in the hand feel user testing were flat knit fabrics of yarn count Ne 16/2. The fabrics are henceforth referred to as unused fabrics (pre-washed) and washed fabrics (washed 10 times). The different fiber types were marked with different letters. Unused samples were marked A-D. Washed samples were marked a-d. Both unused and washed samples were ironed on the face side before testing (Comment: The unused cotton fabric, used in this hand feel study was raw cotton fabric, pre-washed, but otherwise not pre-treated (not scoured) due to time limit to finish tests and long lead time with pre-treatment supplier. The washed cotton fabric had been pre-treated prior to the washing procedures.)

Samples were marked out on the fabrics using a circular 24 cm diameter template from a drapability tester and then cut out by hand with scissors. The samples taken from each fabric were spread on the material and avoiding any irregularities such as neps and holes in the samples. For washed fabrics, loose pills were removed by an adhesive lint roller on the back side of all the samples prior to testing. The materials were conditioned according to SS-EN ISO 139:2005, (20±2° C.) and (65±4) % RH. All results relate only to the samples tested.

### Hand Feel User Test

The test was carried out using an online survey via Microsoft Forms, with the total number of 28 respondents. People were randomly selected, around the area of a shopping mall and a lunch restaurant (by passers, co-workers, and personal contacts). All respondents were unbiased with no connection to the project. The respondents did not work with textiles and/or fibers. The survey was made in Swedish, and the results have been translated into English.

In the survey, different hand feel properties for the fabrics were ranked 1 to 4 by the users (1 being the high end on the scale e.g., 1=most natural). The properties tested were:
Smoothness
Roughness
Luster
Cotton-like
Natural

After the property ranking, the user was asked to rank from 1 to 4, which fabric type, made into a t-shirt or sweater, that they would like to buy the most (1 being most likely to buy). The same procedure was made both for unused fabrics (A-D) and washed fabrics (a-d).

The ranking data was collected and summarized automatically by Microsoft Forms. It is important to note that the overall ranking is weighted by the material's ranking in 1st, 2nd, 3rd and 4th ranking together. For example: material X gets the highest percentage of 1st ranking regarding one property, but at the same time is ranked 3rd and 4th with a high percentage. Another material, Y, may then be overall ranked as 1st as it has a has a high percentage on 1st and 2nd place (although not the highest percentage 1st ranking).

### Example 5—Moisture Regain

The moisture regain according to ISO 6741-1:1989 was determined. As can be seen in Table 7, TTT provides similar moisture regain as lyocell and viscose, but higher than cotton (cotton sample had not been scored).

TABLE 7
Moisture regain

| | Moisture regain (%) ISO 6741-1: 1989 |
|---|---|
| TTT | 13.5 |
| Viscose | 14.9 |
| Lyocell | 13.0 |
| Cotton | 8.4 |

### Example 6—Dry Elongation

The dry elongation according to EN-ISO 5079:1995 was determined on single fibre.
Gauge length: 10 mm for staple fibre
Rate of extension: 10 mm/min
Pretension: none
Number of specimens: 10-20

As can be seen in Table 8, TTT elongates less than lyocell and viscose. It was noted that the tenacity of TTT was lower though (data not shown).

TABLE 8
Dry elongation

| | Dry elongation (%) EN-ISO 5079: 1995 |
|---|---|
| TTT | 10.6 |
| Viscose | 20.6 |
| Lyocell | 13.0 |
| Cotton | 8.9* |

*cotton sample had not been scored

Indeed, it was shown that blending in TTT fibers in a lyocell yarn resulted in less elongation (cf. example 7).

### Example 7—Mixing of Fibers

A number of sample yarns comprising mixture of TTT-fibers and other man-made fibers (lyocell or viscose; commercial sample) or cotton (commercial sample) were produced at RISE Mölndals yarn lab using small scale to pilot scale yarn manufacturing equipment. The yarns produced was benchmarked to the material requirements of 100% cotton yarns in various product segments including bed linen. Ring spun yarns as well as open end spun yarns were produced. The tensile properties, i.e. tenacity (cN/tex) and elongation (%), were tested.

### Opening, Carding and Drafting

All fibers were opened and blended one time in Ramella Opener HL500S using constant and the same speed of the motor and inlet mat for all blends. The fibers where further opened and distributed on the carder inlet mat by hand. The fiber batches were carded in Ramella Carder HL800 using constant fiber density on the mat, 150 g/section. The inlet, outlet and main cylinder speed was constant: 23 (inlet), 30 (outlet) and 45 (main cylinder). Twister diameter used was either 14 mm or 16 mm. The sliver was collected in a coiler device. The slivers were then drafted in Mesdan Stirolab 3371. In the first passage, 6 slivers were drafted together with either 2.95 draft or 3.8 draft. The distance between the first and second stretch was constant. A second drafting, where the sliver drafted once, was doubled, was performed using draft between 1.8-2.5.

### Yarn Spinning

The yarns were developed using either ring spinning (RS) or Open-End (OE)/rotor spinning in RISE yarn lab, Mölndal. Ring spinning equipment Mesdan Ring lab was used. Ring spinning was used in producing samples for further testing. In the reported test data herein, the yarn count was NE16

Ring spinning Ne 16
Prel. Draft: 1.1-1.4
Tot. El Draft: 18-34
Tot. Draft: 82-155
Torsion: Z
Twist: 600-700
Rpm: 6500
m/min: 9-11
Traveller: ISO 63
Traveller weight: 63 mg

### Tensile Testing

The yarn count was measured in accordance with ISO 2060:1994 Textiles-Yarn from packages-Determination of linear density (mass per unit length) by the skein method, using a Zweigle KG. reel. Deviation from standard: The sample length was 25 m and at least two samples per cone were measured.

The tensile properties of the yarns developed were tested according to ISO 2062:2009 (Textiles—Yarns from packages—Determination of single-end breaking force and elongation at break using constant rate of extension (CRE) tester). The tests was made on Instron model 5966 using pneumatic clamps and pretension 0.1 cN/tex and preload velocity of 10 mm/min. Deviation from standard: Number of samples tested per yarn quality was 10.

### Results

In the tested yarns, the tenacity of yarns with 100% cotton or lyocell was about 18 cN/tex, whereas the tenacity for viscose was slightly lower (about 15 cN/tex). Further, viscose by far had the highest elongation at break, confirming the results for single fiber herein above. Furthermore, the tenacity of yarns with 100% TTT-fibers was lower (<10 cN/tex) than for the other man-mace cellulose fibers and lower than cotton.

However, blending TTT fibers with cotton or lyocell increased the tenacity, whereas the effect of blending in viscose was less apparent. Even as little as 10% cotton or lyocell had an effect. Further, yarns with 70% TTT and 30% lyocell, as well as yarns with 50% TTT and 50% cotton, had a significantly higher tenacity, i.e. about 12 cN/tex. Even though, cotton and lyocell yarns have essentially the same tenacity, less lyocell was required to improve the tenacity significantly in a blend with TTT-fiber. It was confirmed that such blends fulfill e.g. the material requirements of 100% cotton yarns in bed linen.

Further, whereas blending viscose fibers with TTT fibers lowered the tenacity, the elongation at break at the same time was reduced. A blend of 70% viscose and 30% TTT had sufficient tenacity, but reduced elongation at break being similar to cotton and lyocell. It was confirmed that TTT fibers may be used to decrease the dry elongation of viscose.

### Industrial Spinning

In subsequent test, it was confirmed that TTT fibers (38 mm, 1.8 dtex) could be processed successfully as blend with Lyocell fibers (38 mm, 1.3 dtex), as 70%/30% blend, respectively, and spun into Ne 24 conventional ring, compact, rotor and air-jet spun yarns in industrial short staple spinning processes. Further, the tenacity of the TTT/lyocell yarn spun by conventional ring spinning and compact spinning was in the same range as for a yarn spun of 100% viscose, whereas the elongation at break was lower (8.6% vs. 12.7%). Both yarns had tenacity of about 16 cN/tex. As expected, the tenacity of yarn spun by rotor or air-jet spinning was lower.

It could thus be confirmed that the findings from the pilot-spinning test with the TTT/lyocell yarn could be reproduced in an industrial setting.

1. A fabric comprising cellulosic fibers regenerated from an alkaline, aqueous solution of dissolved cellulose in a spin bath, and an additional fiber, wherein the dissolved cellulose has a degree of substitution of not more than 0.3.

2. The fabric according to claim 1, wherein the fabric comprises at least 20 wt %, 50 wt %, 60 wt %, 70 wt %, 80 wt %, or 90 wt %, of cellulosic fibers regenerated from the alkaline, aqueous solution of dissolved cellulose.

3. (canceled)

4. The fabric according to claim 1,
wherein the fabric comprises 50 to 99 wt %, 70 to 97.5 wt %, or 80 to 95 wt %, of the cellulosic fibers regenerated from the alkaline, aqueous solution of dissolved cellulose, wherein the fabric comprises the additional fiber selected from the group consisting of: man-made cellulosic fibers distinct from the cellulosic fibers regenerated from the alkaline, aqueous solution of dissolved cellulose, cotton fibers, and polyester fibers.

5. The fabric according to claim 4, wherein the fabric comprises 50 to 90 wt %, 60 to 80 wt %, or 65 to 75 wt %, of the cellulosic fibers regenerated from an alkaline, aqueous solution of dissolved cellulose in a spin bath and lyocell fibers, and wherein the fabric comprises 10 to 50 wt % lyocell fibers, to 40 wt % or 25 to 35 wt % lyocell fibers.

6. The fabric according to claim 4, wherein the fabric comprises 20 to 80 wt %, 30 to 70 wt %, or 40 to 60 wt %, of the cellulosic fibers regenerated from an alkaline, aqueous solution of dissolved cellulose in a spin bath and cotton fibers, and wherein the fabric comprises 20 to 80 wt % cotton fibers, to 70 wt % or 40 to 60 wt % cotton fibers.

7. The fabric according to claim 1, wherein said fabric comprises a dyestuff.

8. The fabric according to claim 7, wherein the fabric has been colored by a dyestuff, and wherein the fabric comprises cellulosic fibers regenerated from the alkaline, aqueous solution of dissolved cellulose and the additional fibers distinct from the cellulosic fibers regenerated from the alkaline, aqueous solution of cellulose, providing the fabric with a mélange effect.

9. The fabric according to claim 1, wherein the fabric is a knitted fabric, or a woven fabric; or
wherein the fabric is a non-woven fabric.

10. The fabric according to claim 9, wherein the fabric is a knitted fabric having a jersey construction with a mass per unit area of 60 to 400 g/m² determined according to SS-EN 12127:1997 with a sampling procedure with load according to ISO 3801:1977, optionally a thickness of 0.5 to 2 mm according to SS-EN ISO 9073-1:1995, and a resistance to surface pilling of at least 3, as determined according to SS-EN ISO 12945-2:2020 in a Martindale apparatus after at least 5000 rubs; or
wherein the fabric is a woven fabric having a thread count of 75 to 600 per square inch, such as 100 to 400 per square inch.

11. The fabric according to claim 1, wherein the cellulosic fibers regenerated from the alkaline, aqueous solution of dissolved cellulose are fibers that, when tested by being incorporated in a flat knit fabric with a single jersey construction with a mass per unit area of 275 to 295 g/m² determined according to SS-EN 12127:1997 with a sampling procedure with load according to ISO 3801:1977, and a thickness of 1.0 to 1.3 mm according to SS-EN ISO 9073-1:1995, provides the single jersey fabric with a resistance to surface pilling of at least 3, as determined according to SS-EN ISO 12945-2:2020 in a Martindale apparatus after at least 5000 rubs.

12. The fabric according to claim 1, wherein the cellulosic fibers regenerated from the alkaline, aqueous solution of dissolved cellulose have a linear density of 0.5-3.0, or 0.8 to 2.0 dtex.

13. The fabric according to claim 1, wherein the cellulosic fibers regenerated from the alkaline, aqueous solution of dissolved cellulose are staple fibers, the staple fibers being 15 to 75 mm long, or 20 to 50 mm long.

14. The fabric according to claim 1, wherein the dissolved cellulose has a degree of substitution of not more than 0.1, or wherein the dissolved cellulose is unsubstituted.

15. (canceled)

16. The fabric according to claim 1, wherein the dissolved cellulose is substituted.

17. The fabric according to claim 1, wherein the alkaline, aqueous solution of dissolved cellulose comprises 5 to 10 wt. % sodium hydroxide, 4 to 12 wt. % cellulose, and optionally 0.1 to 2.7% ZnO.

18. The fabric according to claim 1, wherein the spin bath is an alkaline spin bath, comprising sodium carbonate.

19. The fabric according to claim 1, wherein the cellulosic fibers regenerated from the alkaline, aqueous solution of dissolved cellulose have been regenerated by spinning the alkaline, aqueous solution of dissolved cellulose into the spin bath, wherein the cellulosic fibers regenerated in a spin bath have been formed by dissolving cellulose in an alkaline solution comprising 5 to 12 wt. % sodium hydroxide, at a temperature of +12° C. or lower to form an alkaline spin dope and subsequently spinning the spin dope into an alkaline spin bath comprising 14 to 32 wt. % sodium carbonate (Na₂CO₃) to provide the cellulosic fibers regenerated from the alkaline, aqueous solution of dissolved cellulose.

20. The fabric according to claim 1, wherein the spin bath is an alkaline spin bath, and wherein the cellulosic fibers regenerated from the alkaline, aqueous solution of dissolved cellulose have been washed in a plurality of consecutive washing steps at alkaline conditions.

21. An article comprising a fabric according to claim 1, wherein the article is a home furnishing textile article.

22.-30. (canceled)

31. The fabric according to claim 1, wherein the fabric comprises 1 to 50 wt %, 5 to 40 wt % or 10 to 40 wt %, of the cellulosic fibers regenerated from the alkaline, aqueous solution of dissolved cellulose, wherein the fabric comprises further fibers selected from the group consisting of: man-made cellulosic fibers distinct from the cellulosic fibers regenerated from the alkaline, aqueous solution of cellulose, cotton fibers, and polyester fibers.
